(19) United States
(12) Patent Application Publication
(10) Pub. No.: US 2006/0239894 A1
(43) Pub. Date: Oct. 26, 2006

(54) Carbon nanotube cathode and method of manufacturing the same

(75) Inventors: Hiroyuki Kurachi, Mie (JP); Sashiro Uemura, Mie (JP)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Noritake Co., Ltd.

(21) Appl. No.: 11/347,443

(22) Filed: Feb. 2, 2006

(30) Foreign Application Priority Data
Feb. 7, 2005 (JP) 030226/2005

(51) Int. Cl. C01B 31/02

(52) U.S. Cl. 423/445 R

(57) ABSTRACT

A carbon nanotube cathode includes a substrate, first layer, second layer, and carbon nanotube. The substrate is made of a conductor. The first layer is made of alumina and formed on the substrate. The second layer is formed on the first layer and made of a metal material which serves as a catalyst for carbon nanotube formation. The carbon nanotube has grown from the metal material. A method of manufacturing a carbon nanotube cathode is also disclosed.

### BACKGROUND OF THE INVENTION

The present invention relates to a small-diameter carbon nanotube formed on the surface of a substrate, and a carbon nanotube manufacturing method of forming the carbon nanotube by chemical vapor deposition.

A carbon nanotube forms a completely graphitized cylinder having a diameter of about 4 nm to 50 nm and a length of about 1 μm to 10 μm. Examples of the carbon nanotube include one having a shape in which a single graphite layer (graphene) is closed cylindrically and one having a shape in which a plurality of graphenes are layered telescopically such that the respective graphenes are closed cylindrically to form a coaxial multilayered structure. The central portions of the cylindrical graphenes are hollow. The distal end portions of the graphenes may be closed, or broken and accordingly open.

It is expected that the carbon nanotube having such a specific shape may be applied to novel electronic materials and nanotechnology by utilizing its specific electron properties. For example, the carbon nanotube can be used as an emitter which emits electrons. When a strong electric field is applied to the surface of a solid, the potential barrier of the surface of the solid which confines electrons in the solid becomes low. Consequently, the confined electrons are emitted outside the solid due to the tunnel effect. This phenomenon is so-called field emission.

In order to observe field emission, an electric field of as strong as 10⁷ V/cm must be applied to the solid surface. As a scheme of applying a strong electric field, a metal needle with a sharp point may be used. When an electric field is applied by using such a needle, the electric field concentrates at the sharp point, and a necessary strong electric field is obtained.

The carbon nanotube described above has a very sharp point with a radius of curvature on the nm order, and is chemically stable and mechanically tough, thus providing physical properties suitable for a field emission emitter material. When the carbon nanotube having such a characteristic feature is formed on a substrate having a large area, it can be used as an electron-emitting source in an FED (Field Emission Display) or the like.

Carbon nanotube manufacturing methods include electric discharge in which two carbon electrodes are set apart from each other by about 1 mm to 2 mm in helium gas and DC arc discharge is caused to form a carbon nanotube, laser vapor deposition, and the like.

With these manufacturing methods, however, the diameter and length of the carbon nanotube are difficult to adjust, and the yield of the carbon nanotube as the target cannot be much increased. A large amount of amorphous carbon products other than carbon nanotubes are produced simultaneously. Thus, a purification process is required, making the manufacture cumbersome.

In order to solve these problems, a carbon nanotube manufacturing method employing thermal chemical vapor deposition (CVD) is proposed, in which a metal substrate is prepared and a carbon source gas is supplied onto the surface of the substrate, while the substrate is heated, to grow a large amount of carbon nanotubes from the substrate (for example, see Japanese Patent Application Nos. 2000-037672 and 2003-195325). With this method, the length and diameter of the carbon nanotube to be formed can be controlled depending on the type of the metal substrate, the duration of growth, and the like.

When a carbon nanotube is used as an electron-emitting source, if a uniform-thickness carbon nanotube film formed of thinner carbon nanotubes is used, electrons can be emitted stably at a lower voltage. For example, when a carbon nanotube is used as an electron-emitting source in an FED, if a thinner carbon nanotube is used, low-voltage driving is enabled. This is preferable in terms of power consumption saving. When the uniform-thickness carbon nanotube film is used, local field concentration can be prevented. This is desirable in stabilizing field emission.

With the conventional carbon nanotube manufacturing method employing thermal chemical vapor deposition, a carbon nanotube is formed from the metal substrate directly, as described above. Metal in the metal substrate serves as a catalyst to form the carbon nanotube. Hence, the diameter of the carbon nanotube depends on the growing temperature. The higher the temperature, the thinner the carbon nanotube. For example, at 650° C., the diameter of the carbon nanotube is about 40 mm, whereas at 900° C., the diameter of the carbon nanotube becomes about 10 nm to 20 nm. With the method of forming the carbon nanotube directly from the metal substrate in this manner, however, a carbon nanotube having a diameter of 10 nm or less can be hardly formed.

### SUMMARY OF THE INVENTION

The present invention has been made to solve the above problems, and has as its object to form a thinner carbon nanotube.

It is another object of the present invention to form a uniform-thickness carbon nanotube layer on a substrate.

In order to achieve the above objects, according to the present invention, there is provided a carbon nanotube cathode manufacturing method comprising the steps of forming a first layer made of alumina on a substrate made of a conductor, forming a second layer, made of a metal material which serves as a catalyst for carbon nanotube formation, on the first layer, and arranging the substrate, on which the first layer and the second layer are formed, in a reactor, and introducing a carbon source gas in the reactor to grow a plurality of carbon nanotubes on the substrate by chemical vapor deposition.

According to the present invention, there is also provided a carbon nanotube cathode comprising a substrate made of a conductor, a first layer made of alumina and formed on the substrate, a second layer formed on the first layer, the second layer being made of a metal material which serves as a catalyst for carbon nanotube formation, and a carbon nanotube grown from the metal material.

### BRIEF DESCRIPTION OF THE DRAWINGS

FIGS. 1A to 1D are views showing the steps in a carbon nanotube cathode manufacturing method according to the first embodiment of the present invention;

FIG. 2 is an electron micrograph of carbon nanotubes formed according to the first embodiment of the present invention;

FIGS. 3A to 3E are views showing the steps in a carbon nanotube cathode manufacturing method according to the second embodiment of the present invention;

FIG. 4 is an electron micrograph showing the plan view of carbon nanotubes formed according to the second embodiment of the present invention;

FIG. 5 is an electron micrograph showing the section of the carbon nanotubes formed according to the second embodiment of the present invention;

FIG. 6 is an electron micrograph of carbon nanotubes formed according to the second embodiment of the present invention; and

FIGS. 7A to 7E are views showing the steps in a carbon nanotube cathode manufacturing method according to the third embodiment of the present invention.

### DESCRIPTION OF THE PREFERRED EMBODIMENTS

Preferred embodiments of the present invention will be described in detail with reference to the accompanying drawings.

### First Embodiment

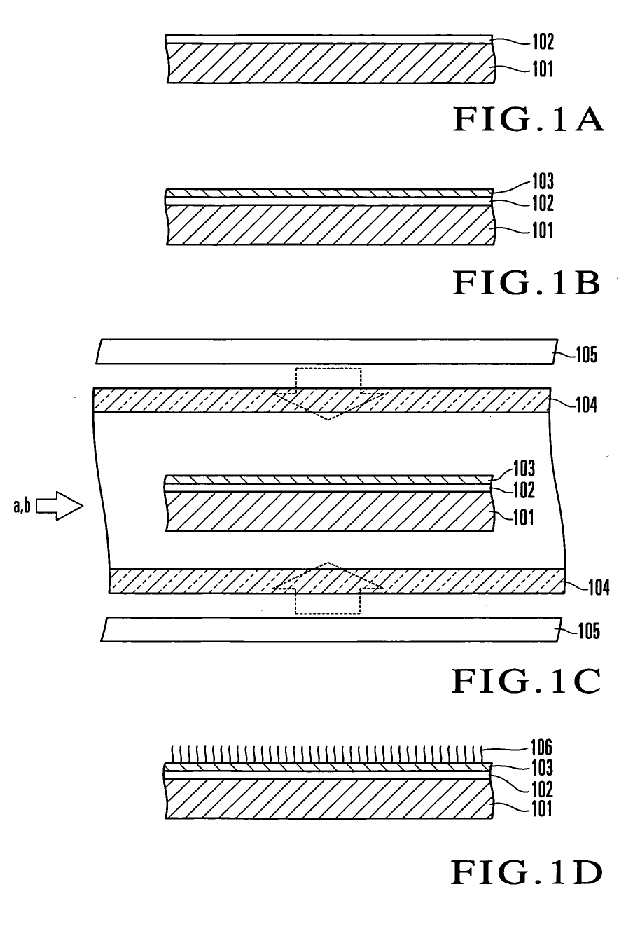

A carbon nanotube cathode manufacturing method according to the first embodiment of the present invention will be described with reference to FIGS. 1A to 1D.

First, a substrate 101 made of a conductive material is prepared. As shown in FIG. 1A, a first layer 102 made of alumina (Al₂O₃) is formed on the substrate 101. The thickness of the first layer 102 is sufficient if steps and voids can be formed in the first layer 102, and is 1 nm to 1,000 nm and preferably 5 nm to 100 nm. The first layer 102 is formed by a known deposition method, sputtering, dip coating, spin coating, or the like.

Subsequently, as shown in FIG. 1B, a second layer 103 having a thickness of 0.1 nm to 10 nm, and preferably 0.5 nm to 5 nm, is formed on the first layer 102. The second layer 103 may be made of a metal material, e.g., iron, nickel, cobalt, or their alloy which serves as a catalyst in carbon nanotube formation. The second layer 103 is formed by a known deposition method, sputtering, dip coating, spin coating, or the like.

Subsequently, as shown in FIG. 1C, the substrate 101 on which the first and second layers 102 and 103 are formed is placed in a reactor 104 formed of, e.g., a quartz tube. While supplying a source gas a (carbon source gas) and hydrogen gas (carrier gas) b to the reactor 104 from one side, the substrate 101 is heated by a heater 105. As the source gas a, one of hydrocarbon gases having one to three carbon atoms such as acetylene, ethylene, ethane, propylene, propane, or methane gas may be used with a flow rate of about 20 sccm to 200 sccm. The heating temperature for the substrate 101 may be about 700° C. to 1,000° C.

When the above chemical vapor deposition process is performed for 10 min to 60 min, carbon nanotubes 106 grow on the second layer 103 formed on the first layer 102, as shown in FIG. 1D. At this time, the catalyst metal that forms the second layer 103 is supposed to be melted, when the substrate 101 is heated, to fill the steps and voids in the surface of the first layer 102. As the sizes of the steps and voids of the first layer 102 are as small as about 1 nm to 10 nm, the catalyst metal is held in a fine state by the first layer 102. The carbon nanotubes 106 grow from the respective fine catalyst metal portions.

The diameters of the carbon nanotubes grown on the catalyst metal by the chemical vapor deposition described above are controlled by the sizes of the catalyst metal portions. According to this embodiment, probably, the steps and voids of the first layer 102 hold the catalyst metal particles which form the second layer 103 in the fine state while the carbon nanotubes 106 are being grown by chemical vapor deposition. Consequently, according to this embodiment, the carbon nanotubes 106 having diameters of about 4 nm to 15 nm are formed on the substrate 101. The thickness of the layer of the carbon nanotubes 106 is uniform.

According to this embodiment, as described above, many voids are formed in the first layer 102, and the substrate 101 and the catalyst metal that forms the second layer 103 are probably rendered conductive through the voids. Hence, the substrate 101 on which the carbon nanotubes 106 are formed can be used as an electron-emitting source in an FED or the like.

A practical example of this embodiment will be described. First, a 10-nm thick first layer 102 made of alumina was formed on a substrate 101 formed of a 426-alloy substrate by deposition. A 3-nm thick second layer 103 made of iron was formed on the first layer 102 by deposition.

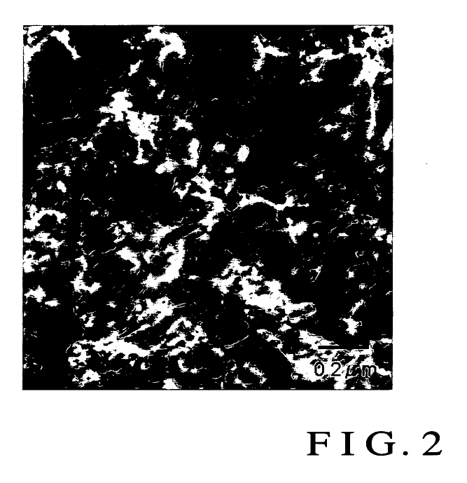

Subsequently, the substrate 101 on which the first and second layers 102 and 103 were formed was placed in a reactor 104 and heated to 900° C. while supplying hydrogen gas b at 1 [L/min]. When the temperature of the substrate 101 reached 900° C., carbon monoxide (CO) was supplied as a source gas a into the reactor 104 at 0.25 [L/min] for 30 min to grow carbon nanotubes 106 as shown in FIG. 2 on the second layer 103. As is apparent from FIG. 2, a uniform-thickness carbon nanotube layer (film) comprising the highly dense carbon nanotubes 106 having diameters of about 5 nm to 15 nm was formed on the substrate 101.

The carbon nanotube cathode according to the first embodiment comprises the substrate 101, the first layer 102 formed on the substrate 101, the second layer 103 formed on the first layer 102, and the carbon nanotubes 106 grown from the catalyst metal which forms the second layer 103.

### Second Embodiment

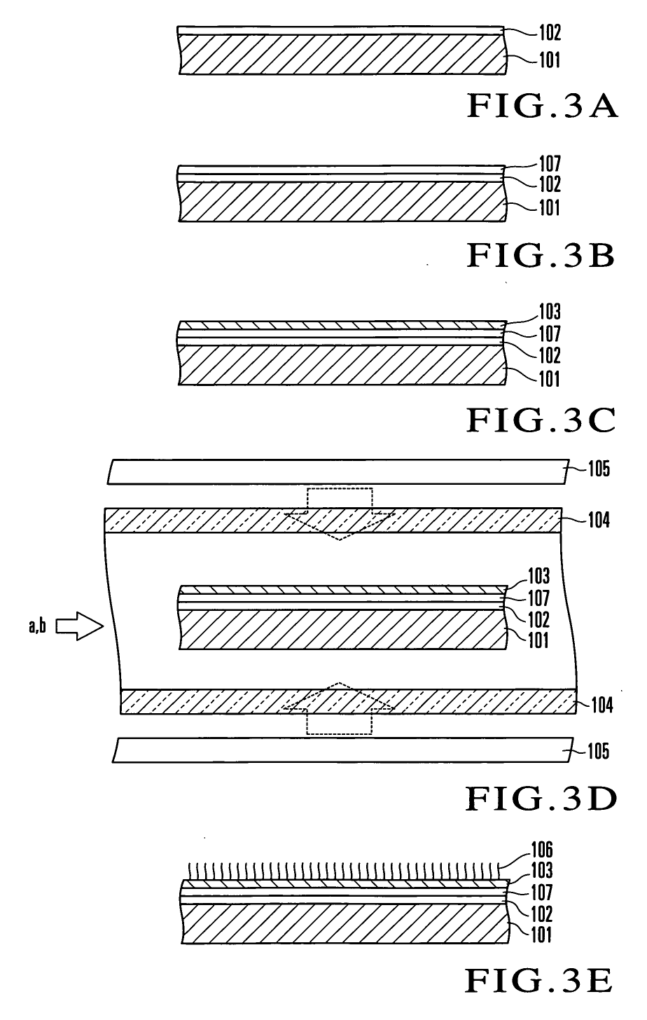

A carbon nanotube cathode according to the second embodiment of the present invention will be described with reference to FIGS. 3A to 3E. In the second embodiment, the identical constituent elements to those of the first embodiment are denoted by the same names and reference numerals, and a description thereof will be omitted appropriately.

First, as shown in FIG. 3A, a first layer 102 is formed on a substrate 101. After that, as shown in FIG. 3B, a third layer 107 made of a material having a higher melting point than that of a catalyst metal is formed on the first layer 102. As the refractory material, molybdenum, tungsten, tantalum, chromium, or the like is used. The thickness of the third layer 107 is sufficient if the third layer 107 does not completely fill steps and voids in the first layer 102, and is 0.1 nm to 10 nm and preferably 1 nm to 5 nm. The third layer 107 is formed by a known deposition method, sputtering, dip coating, spin coating, or the like.

Subsequently, as shown in FIG. 3C, a second layer 103 is formed on the third layer 107. As shown in FIG. 3D, the substrate 101 on which the first, second, and third layers 102, 103, and 107 are formed is placed in a reactor 104. While supplying a source gas a and hydrogen gas b to the reactor 104 from one side, the substrate 101 is heated by a heater 105.

When the above chemical vapor deposition process is performed for 10 min to 60 min, carbon nanotubes 106 grow on the second layer 103 formed on the first layer 102, as shown in FIG. 3E. At this time, a catalyst metal that forms the second layer 103 is supposed to be held in a fine state by the steps and voids in the first and third layers 102 and 107.

The third layer 107 is formed on the first layer 102 having the steps and voids. It is supposed that some of the particles of a material that forms the third layer 107 fill the steps and voids in the first layer 102. Therefore, probably, the steps and voids which are formed in the first and third layers 102 and 107 of the second embodiment have finer outer shapes than those of the steps and voids formed in the first layer 102 of first embodiment, and the intervals among the adjacent steps and voids are larger than those of the first embodiment.

When the substrate 101 is heated, the catalyst metal that forms the second layer 103 is melted to fill the finer steps and voids in the third layer 107. At this time, the third layer 107 made of the refractory material fixes the catalyst metal to prevent it from moving to aggregate. Hence, the catalyst metal is stably held in a finer state by the first and third layers 102 and 107. Consequently, the carbon nanotubes 106 grow thinner to form a uniform-thickness layer of the carbon nanotubes 106 on the substrate 101.

As the intervals among the adjacent catalyst metal particles increase, the density of the layer of the carbon nanotubes 106 formed on the substrate 101 becomes lower than that of the first embodiment, and the distal ends of the carbon nanotubes 106 are spaced apart from each other appropriately. When the substrate 101 is used as an electron-emitting source in an EFD, the electric field tends to concentrate at the distal end of each carbon nanotube 106. As a result, the driving voltage can be decreased.

According to this embodiment, as described above, many voids are formed in the first and third layers 102 and 107, and the substrate 101 and the catalyst metal that forms the second layer 103 are probably rendered conductive through the voids. Hence, the substrate 101 on which the carbon nanotubes 106 is formed can be used as an electron-emitting source in an FED or the like.

The first practical example of this embodiment will be described. First, a 10-nm thick first layer 102 made of alumina was formed on a substrate 101 formed of a 426-alloy substrate. A 5-nm thick third layer 107 made of molybdenum (Mo) was formed on the first layer 102. A 3-nm thick second layer 103 made of iron was formed on the third layer 107. The first, third, and second layers 102, 107, and 103 were respectively formed by deposition.

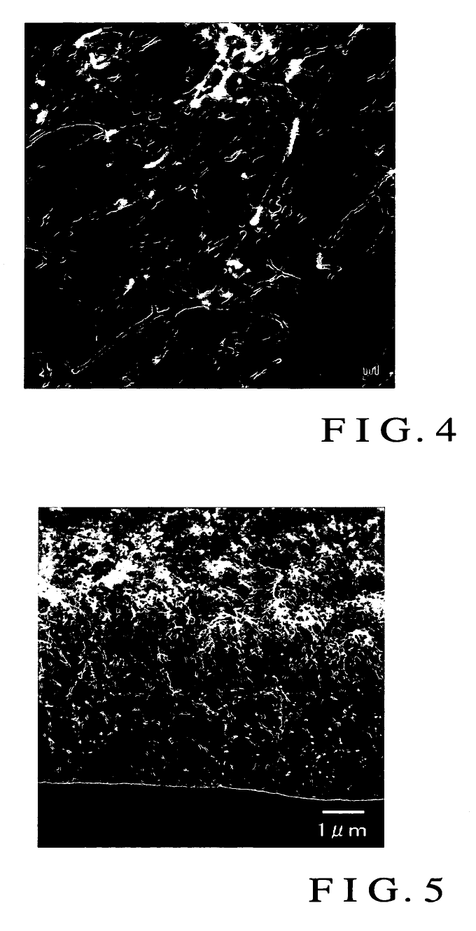

Subsequently, the substrate 101 on which the first, third, and second layers 102, 107, and 103 were formed was placed in a reactor 104 and heated to 800° C. while supplying hydrogen gas b at 1 [L/min]. When the temperature of the substrate 101 reached 800° C., carbon monoxide (CO) was supplied as a source gas a into the reactor 104 at 0.25 [L/min] for 30 min to grow carbon nanotubes 106 on the second layer 103. FIGS. 4 and 5 are electron micrographs showing the plan structure and sectional structure, respectively, of the carbon nanotubes 106.

As shown in FIG. 4, a layer of the carbon nanotubes 106 having diameters of about 10 nm to 20 nm was formed on the substrate 101. As seen well in FIG. 5, this layer had a uniform thickness of about 4 μm to 5 μm. The carbon nanotubes 106 had a lower density than in the first embodiment. When the substrate 101 on which the carbon nanotube layer was formed was used as an electron-emitting source in an FED, the FED could be driven at a lower voltage than in the first embodiment.

The second practical example of this embodiment will be described. This practical example is the same as the first practical example except that a third layer 107 is formed of chromium (Cr) and that carbon monoxide (CO) is supplied when the interior of a reactor 104 reaches 900° C.

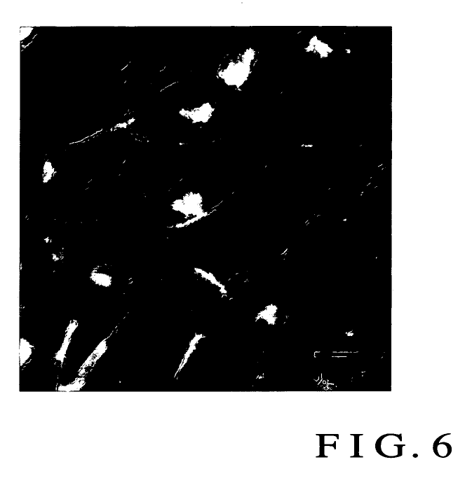

According to this practical example, as shown in FIG. 6, carbon nanotubes 106 having diameters of about 5 nm to 10 nm, which were thinner than those of the practical example of the first embodiment or the first practical example of the second embodiment described above, were formed on a substrate 101. The layer of the carbon nanotubes 106 had a uniform thickness. The density of the carbon nanotubes 106 was lower than in the practical examples described above. The layer of the carbon nanotubes 106 also contained DWNTs (Double Wall carbon NanoTubes) having diameters of about 6 nm. When the substrate 101 on which this layer was formed was used as an electron-emitting source in an FED, the FED could be driven at a lower voltage than in the first embodiment.

The carbon nanotube cathode according to the second embodiment comprises the substrate 101, the first layer 102 formed on the substrate 101, the third layer 107 formed on the first layer 102, the second layer 103 formed on the third layer 107, and the carbon nanotubes 106 grown from the catalyst metal which forms the second layer 103.

### Third Embodiment

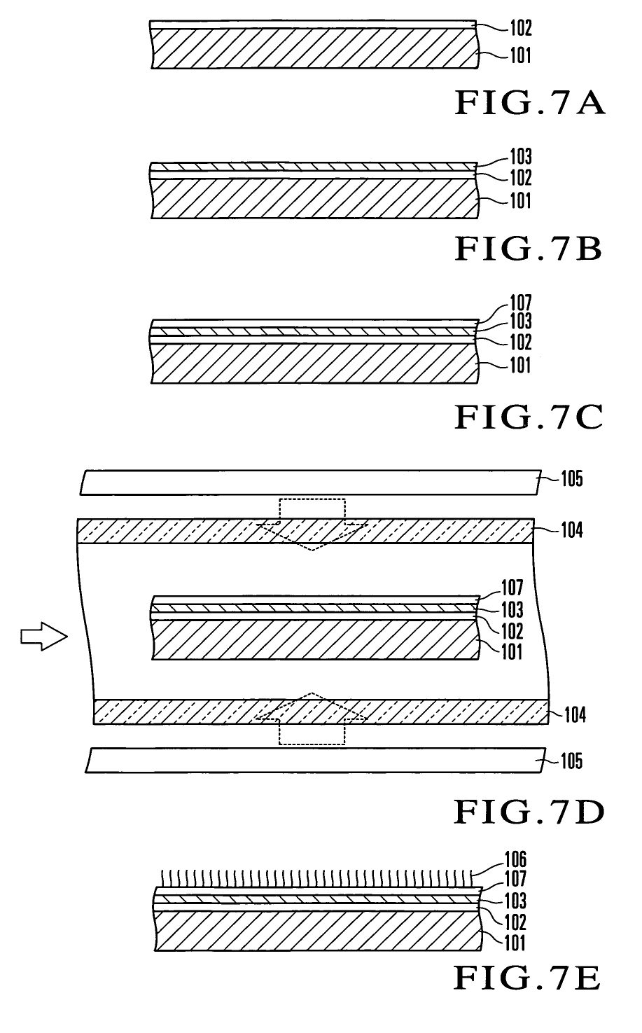

A carbon nanotube cathode according to the third embodiment of the present invention will be described with reference to FIGS. 7A to 7E. In the third embodiment, the identical constituent elements to those of the first and second embodiments are denoted by the same names and reference numerals, and a description thereof will be omitted appropriately.

First, as shown in FIG. 7A, a first layer 102 is formed on a substrate 101. After that, as shown in FIG. 7B, a second layer 103 is formed on the first layer 102. Furthermore, as shown in FIG. 7C, a third layer 107 is formed on the second layer 103. The thickness of the third layer 107 is sufficient if the third layer 107 does not completely cover the second layer 104, and is 0.1 nm to 10 nm and preferably 1 nm to 5 nm.

Subsequently, as shown in FIG. 7D, the substrate 101 on which the first, second, and third layers 102, 103, and 107 are formed is placed in a reactor 104. While supplying a source gas a and hydrogen gas b to the reactor 104 from one side, the substrate 101 is heated by a heater 105.

When the above chemical vapor deposition process is performed for 10 min to 60 min, carbon nanotubes 106 grow on the third layer 107 formed on the second layer 103, as shown in FIG. 7E. At this time, a catalyst metal that forms the second layer 103 is supposed to be held in a fine state by steps and voids in the first and third layers 102 and 107. Particularly, when the third layer 107 is formed on the second layer 103, the catalyst metal which forms the second layer 103 is fixed by the third layer 107 made of a high-melting material and accordingly does not aggregate readily, so the catalyst metal is stably held in a finer state. Hence, the carbon nanotubes 106 grow thinner from the catalyst layer which forms the second layer 103 to consequently form a uniform-thickness layer of the carbon nanotubes 106 on the substrate 101.

As the third layer 107 is formed on the second layer 103, it is supposed that some of the particles of the material that forms the third layer 107, together with the catalyst metal which forms the second layer 103, fill the steps and voids in the first layer 102. Therefore, the intervals among adjacent catalyst metal portions increase. The density of the layer of the carbon nanotubes 106 formed on the substrate 101 accordingly becomes lower than that of the first embodiment, and the distal ends of the carbon nanotubes 106 are spaced apart from each other appropriately. When the substrate 101 is used as an electron-emitting source in an FED, the electric field tends to concentrate at the distal end of each carbon nanotube 106. As a result, the driving voltage can be decreased.

The substrate 101 according to this embodiment, on which the carbon nanotubes 106 are formed, can be used as an electron-emitting source in an FED or the like. This is the same as in the first and second embodiments.

A practical example of this embodiment will be described. First, a 10-nm thick first layer 102 made of alumina was formed on a substrate 101 formed of a 426-alloy substrate. A 3-nm thick second layer 103 made of iron was formed on the first layer 102. Furthermore, a 5-nm thick third layer 107 made of molybdenum (Mo) was formed on the second layer 103. The first, second, and third layers 102, 103, and 107 were respectively formed by deposition.

Subsequently, the substrate 101 on which the first, second, and third layers 102, 103, and 107 were formed was placed in a reactor 104 and heated to 800° C. while supplying hydrogen gas b at 1 [L/min]. When the temperature of the substrate 101 reached 800° C., carbon monoxide (CO) was supplied as a source gas a into the reactor 104 at 0.25 [L/min] for 30 min to grow carbon nanotubes 106 on the second layer 103.

With this method, a uniform-thickness layer of the carbon nanotubes 106 having diameters of about 10 nm to 20 nm and a density lower than that in the first embodiment was formed on the substrate 101. When this substrate 101 was used as an electron-emitting source in an FED, the FED could be driven at a lower voltage than in the first embodiment.

The carbon nanotube cathode according to the third embodiment comprises the substrate 101, the first layer 102 formed on the substrate 101, the second layer 103 formed on the first layer 102, the third layer 107 formed on the second layer 103, and the carbon nanotubes 106 grown on the third layer 107 from the catalyst metal which forms the second layer 103.

As described above, according to the present invention, when the first layer 102 made of alumina is formed on the substrate 101, the carbon nanotubes 106 thinner than in the conventional case can be formed. The layer of the carbon nanotubes 106 has a uniform thickness. Such a layer of the carbon nanotubes 106 is formed probably because since the steps and voids are formed in the first layer 102, the catalyst metal which forms the second layer 103 is held in a fine state by the steps and voids in the first layer 102.

According to the present invention, when the third layer 107 made of any one of molybdenum, tungsten, tantalum, and chromium is formed on the first layer 102 made of alumina, the carbon nanotubes 106 can be formed thinner. The layer of the carbon nanotubes 106 has a uniform thickness, and the density of the carbon nanotubes 106 is lower than in a case wherein the third layer 107 is not formed. Such a layer of the carbon nanotubes 106 is formed probably because as the first and third layers 102 and 107 form the finer steps and voids with larger intervals, the catalyst metal which forms the second layer 103 is held in a fine state by the first and third layers 102 and 107, and the intervals among the adjacent catalyst metal portions increase.

The same function and effect can be obtained when the second layer 103 made of the catalyst metal is formed on the first layer 102 made of alumina and the third layer 107 made of any one of molybdenum, tungsten, tantalum, and chromium is formed on the second layer 103.

What is claimed is:

1. A carbon nanotube cathode manufacturing method comprising the steps of:
forming a first layer made of alumina on a substrate made of a conductor;
forming a second layer, made of a metal material which serves as a catalyst for carbon nanotube formation, on said first layer; and
arranging the substrate, on which the first layer and the second layer are formed, in a reactor, and introducing a carbon source gas in the reactor to grow a plurality of carbon nanotubes on the substrate by chemical vapor deposition.

2. A method according to claim 1, further comprising the step of forming a third layer made of any one of molybdenum, tungsten, tantalum, and chromium on the first layer,
wherein in the step of forming the second layer, the second layer is formed on the third layer formed on the first layer, and
in the step of growing the carbon nanotubes, the substrate on which the first to third layers are formed is arranged in the reactor.

3. A method according to claim 1, further comprising the step of forming a third layer made of any one of molybdenum, tungsten, tantalum, and chromium on the second layer,
wherein in the step of growing the carbon nanotubes, the substrate on which the first to third layers are formed is arranged in the reactor.

4. A method according to claim 1, wherein the metal material is any one of iron, nickel, cobalt, and an alloy thereof.

5. A carbon nanotube cathode comprising:
a substrate made of a conductor;
a first layer made of alumina and formed on said substrate;
a second layer formed on said first layer, said second layer being made of a metal material which serves as a catalyst for carbon nanotube formation; and
a carbon nanotube grown from said metal material.

6. A cathode according to claim 5, further comprising a third layer formed between said first layer and said second layer, said third layer being made of any one of molybdenum, tungsten, tantalum, and chromium.

7. A cathode according to claim 5, further comprising a third layer formed on said second layer, said third layer being made of any one of molybdenum, tungsten, tantalum, and chromium,
wherein said carbon nanotube has grown from said metal material on said third layer.
